(19) United States
(12) Patent Application Publication
(10) Pub. No.: US 2007/0109951 A1
(43) Pub. Date: May 17, 2007

(54) Data distributing-machine with controled atmosphere

(76) Inventor: Goulven Jean Vernois, (US)

Correspondence Address: Vernois, 8 Sentier des Laminaires, Arradon, 56610, FR

(21) Appl. No.: 10/561,836

(22) PCT Filed: Jun. 10, 2004
(86) PCT No.: PCT/FR04/01456

§ 371 Date: Dec. 21, 2005

(30) Foreign Application Priority Data
Jun. 19, 2003 (FR) 03/07429

(51) Int. Cl. G11B 9/00; G06F 17/00

(52) U.S. Cl. 369/126; 700/232

(57) ABSTRACT

A tight enclosure 1 receives by an airlock 2 virgin optical discs 3 sensitive to oxygen and packed in a tight packing 4. These discs are came out of their tight packing 4 by a means 7, introduced into a means of writing 6, and again introduced into a tight packing 4a by a means of tight packaging 11. Then they are got out of enclosure 1 through an airlock 5.

### FIELD OF THE INVENTION

The field of the invention is that of the distribution of the digital data, and more particularly that of the hiring of these data.

### FORMER STATE OF THE ART

One knows that there are optical discs of which matter is subjected to change of colouring under the influence of oxygen and/or the light, making them unsuitable with the reading at the end of a definite time, and/or a definite number of readings (apart from an accidental exposure to the light).

These optical discs are designed for the hiring.

They are sold in airtight or opaque envelopes which it is necessary to open to read the disc.

The higher price of the discs and the price of their envelopes involves a higher cost of the stock.

### GOAL OF THE INVENTION

The purpose of the invention is to promote the hiring of these optical discs by removing the cost due to the stocking of the written discs of the former art.

### SUMMARY OF THE INVENTION

This goal is reached by integrating into an automatic autonomous distributing-machine of former art (application Fr 0307104) an enclosure tight with gases and/or opaque, free from oxygen, in which there are a stock of virgin discs, a means to writte these virgin discs, and a means to package the written discs in an individual enclosure tight and/or opaque, free from oxygen.

An autonomous data distributing-machine includes at least:
a means of mass memory,
a means to read this mass memory,
a means to choose data from this mass memory,
a means to write on separate supports the chosen data,
a reserve of separate supports,
a means of availability of the separate support containing the data chosen,
   a separate data support being a portable autonomous means having at least a means of information storage, and being able to be put in relation with the means to write the data chosen, for example an optical disc.

### SHORT DESCRIPTION OF THE FIGURES

FIG. 1—Schematic overall picture of the tight enclosure 1 and of its annexes 12 and 13

FIG. 2—Schematic sight of a container 4b fixed at the frame of the door of the airlock of entrance 2

### ITEMS LIST

1—Tight enclosure free from oxygen
2—Airlock of entrance for the virgin discs 3
2a—External door of the airlock of entrance 2
2b—Interior door of the airlock of entrance 2
3—Virgin discs
3a—Written discs
4—Individual packing of the virgin discs 3
4a—Individual packing of the written discs 3a
4b—Container multipack of the virgin discs 3
4c—Lid of the container 4b
5—Airlock of exit of the written discs 3a
5a—External door of the airlock of exit 5
5b—Internal door of the airlock of exit 5
6—Means of writing on the virgin discs 3
7—Means of extraction of the virgin discs 3 from their packing 4
8—Tool used by the means of extraction 7
9—Means of intermediate stocking of the virgin disks 3 got out from their packing 4
10—Means of handling of the virgin discs 3 and written discs 3a
11—Means of individual packaging of the written discs 3a
12—Means of extraction of air
13—Stock of inert gas
14—Means of the airlock 2 allowing the opening of the lid 4c of the containers 4b
15—Safety device of the airlock 2
16—Derivative circuit for analysis and purification of the atmosphere of the enclosure 1
17—Stock of tight packings 4a for packaging of written disks 3a

### DETAILED DESCRIPTION

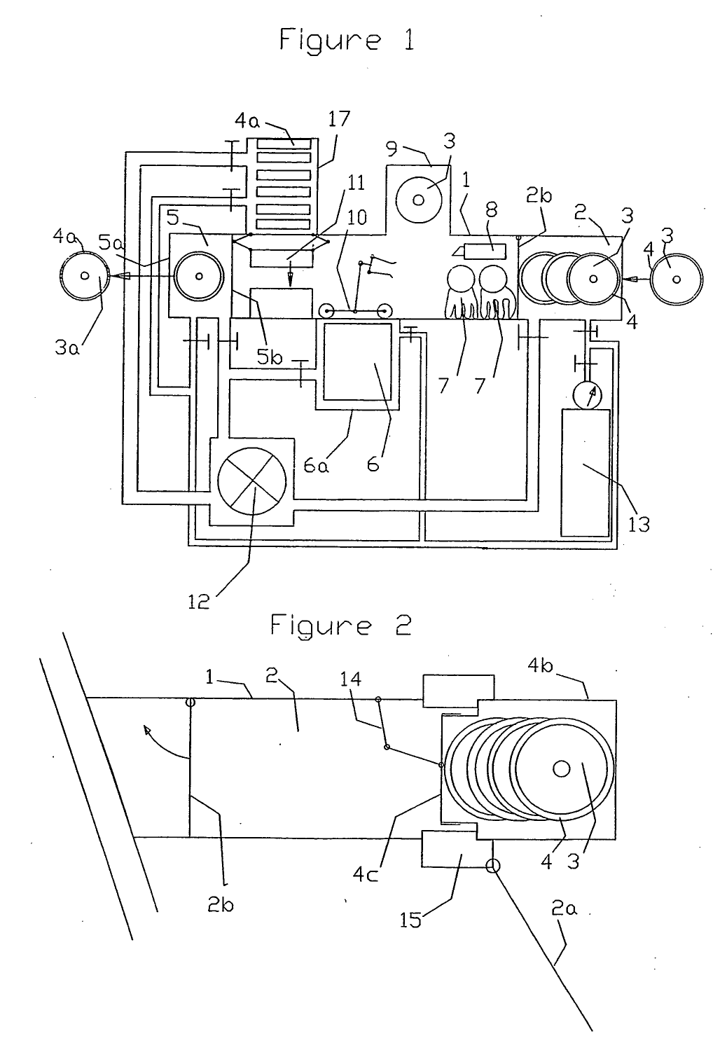

First Preferred Realization (FIG. 1).

An enclosure 1, airtight and free from oxygen, has at least:
an airlock of entrance 2, having a outside door 2a and an interior door 2b, by which it is possible to introduce virgin discs 3 into their airtight packing 4, individual or collective, free from oxygen;
an airlock of exit 5, having an outside door 5a and an interior door 5b, by which will come out the written discs 3a, in their individual airtight packing 4a free from oxygen;
a means of writing 6 on the virgin discs 3 of the selected data;
a means of extraction 7 of the virgin discs 3 of their packing seals 4, collective or individual, for example airtight gloves 7a accessible from the outside of enclosure 1 and making it possible to handle simple tools 8 located in the enclosure, for example a cutter;
a means of storage 9 of the virgin discs 3 got out of their packings 4;
a means of handling 10, for example a carriage provided with devices of gripping and being able to move from airlock of entry 2 to the airlock of exit 5, to introduce the virgin discs 3 extracts of their packing into the means of writing 6, and to come out the written discs 3a from it;
a means of individual packing 11 locking up the written discs 3a in an individual airtight packing 4a free from oxygen;
a stock 17 of tight individual packing 4a, or materials and means to constitute such tight individual packing 4a, possibly in a airlock 17;
a means 12 of extraction of the air introduced into the airlock of entry 2 and exit 5, for example a vacuum pump;
an inert gas stock 13.
   Second Preferred Realization

This realization differs from the preceding realization in what:
the airlock of entry 2 has a form and dimensions such as airtight packing 4 can be contained there exactly,
the airtight packing 4 consists of a container 4b rigid or semi-rigid having a lid 4c,
the residual air between this airlock 2 and the container 4b is driven out by a neutral gas circulation, possibly associated with an extraction of the air by means 12, a means 14 of the airlock 2 opens and shuts the lid 4c to make it possible by means of handling 10 to use the virgin discs 3.
   of tight packings 4a for the packaging of the written discs 3a
   Third Preferred Realization

This realization differs from the preceding achievements in what:
the shape and dimensions of the airlock of entrance 2 are such as the lid part of the container 4b adapts very exactly and in a tight way with the interior door frame 2b of this airlock of entrance 2,
the air contained between the lid 4c of the container 4b and the interior door 2b of the airlock 2 is driven out by a neutral gas circulation, possibly associated with an extraction of the air by means 12,
the connection between airlock 2 and the container 4b is ensured by a device 15 prohibiting the removal of the container if the interior door 2b and the lid 4c of the container are not closed,
the means 14 of the airlock 2 opens and shuts the lid 4c of the container 4b to allow by means of handling 10 to use the virgin discs,
the device 15 forbids the opening of the interior door 2b of the airlock 2 if the sweeping by the neutral gas were not done.
   Fourth Preferred Realization (FIG. 2)

This realization differs from the preceding achievements in what:
the shape and dimensions of the airlock of entrance 2 are such as the lid part of the container 4b adapts very exactly and in a tight way with the frame of the external door of this airlock of entrance 2;
the air contained in airlock 2, between the lid 4c of the container 4b and the interior door 2b of airlock 2 is expelled by a neutral gas circulation, possibly associated with an extraction of the air by means 12;
the connection between airlock 2 and the container 4b is ensured by a device 15 prohibiting the removal of the container 4b if the interior door 2b of airlock 2 and the lid 4c of container 4 are not closed;
the means 14 of the airlock 2 opens and shuts the lid 4c of the container 4b.
   Fifth Preferred Realization (FIG. 1)

This realization differs from the preceding achievements in what:
there exists in the tight enclosure 1, or out side of this one, in a derived circuit 16 recycling the atmosphere of this enclosure 1, a means to fix oxygen, for example an oxydable simple element;
there exists in the tight enclosure 1, or in the derived circuit 16, an oxygen detector possibly connected to a warning system.
   Sixth Preferred Realization (FIG. 1)

This realization differs from the preceding achievements in what:
the means of writing 6 on the independent supports virgin 3 is in an airlock 6a allowing its extraction without introduction of air into the tight enclosure 1.
   Seventh Preferred Realization

This realization differs from the preceding achievements in what:
when the virgin discs 3 are in individual packing 4 tight and free from oxygen, this packing is opened and re-used like packing of the written discs 3a, for example, packing 4 of discs 3 has a diameter largely higher than that of the discs 3 contents and their sealing is assured close to their periphery;
under these conditions means 7 of extraction of discs 3 of their packing eliminates the periphery ensuring the sealing by leaving around disc 3 a sufficient space to ensure a new sealing;
the remaining elements of packing 4 are transferred towards means 11 of packaging of the written discs 3a which places a disc written between the said remaining elements and ensures the sealing of the new packing by a welding of these elements to their periphery.

1) Data distributing-machine including at least:
a mass memory;
a means of selection of data of this mass memory;
a means of writing the selected data on data independent supports;
a stock of data independent supports;
a means of availability of the data independent support containing the selected data;
characterized in that it exists in this data distributing-machine a tight enclosure free from oxygen having at least:
a means to insert into this tight enclosure virgin sensitive optical disks free from oxygen;
a mean to extract the virgin sensitive optical disks from their tight packings
a means to write on these virgin sensitive optical disks;
a means to individually package the written sensitive optical disks, using stocked or manufactured packings, or re-using individual packings of origin;
a means to remove from the tight enclosure sealed written sensitive optical disks free from oxygen.

2) Data distributing-machine according to claim 1,
characterized in that the means of introduction of the virgin sensitive optical disks and the means of remove of the written sensitive optical disks are airlocks.

3) Data distributing-machine according to claim 2,
characterized in that the virgin sensitive optical disks are contained in a tight container free from oxygen and in that the dimensions of the airlock of entrance and of this container are such as the container is contained exactly in the airlock of entrance.

4) Data distributing-machine according to claim 2,
characterized in that the virgin sensitive optical disks are contained in a tight container free from oxygen having a lid part adapting very exactly and in a tight way to the airlock of entrance.

5) Data distributing-machine according to claim 1,
characterized in that the virgin sensitive optical disks are individually or collectively tight packed and in that a means of extraction extracts the said sensitive optical disks from their packings.

6) Data distributing-machine according to claim 1,
characterized in that original individual tight packings of the virgin sensitive optical disks are sealed in making sufficient space for an second sealing by means of individual packaging, after opening by means of extraction.

7) Data distributing-machine according to claim 1,
characterized in that the means of writing of the sensitive optical disks is located in an airlock allowing its extraction without introduction of oxygen into the tight enclosure.

8) Data distributing-machine according to claim 1,
characterized in that a means of stocking of the free sensitive optical disks in the tight enclosure has an airlock allowing to remove these free sensitive optical disks from the tight enclosure.
